(19) United States
(12) Patent Application Publication
(10) Pub. No.: US 2004/0200322 A1
(43) Pub. Date: Oct. 14, 2004

(54) High-torque reversible ratcheting wrench

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/814,567

(22) Filed: Mar. 31, 2004

(30) Foreign Application Priority Data
Apr. 14, 2003 (TW) 92108756

(51) Int. Cl. B25B 13/46

(52) U.S. Cl. 81/63.2

(57) ABSTRACT

A reversible ratcheting wrench includes a handle having a head, a drive member rotatably received in a hole, and a pawl slidably received in the compartment that is defined in an inner periphery delimiting the hole and that is communicated with the hole. A plurality of teeth are formed on a toothed side thereof and have a radius of curvature larger than that of teeth on an outer periphery of the drive member. When the pawl is in either ratcheting position, a portion of the teeth of the pawl meshes with the teeth of the drive member and the other portion of the teeth of the pawl are disengaged from the teeth of the drive member, leaving gap to avoid the seesaw effect that damages the teeth of the pawl and that reduces the torque-bearing capacity.

### BACKGROUND OF THE INVENTION

1. Field of the Invention

The present invention relates to a reversible ratcheting wrench. In particular, the present invention relates to a high-torque reversible wrench.

2. Description of the Related Art

FIG. 1 of the drawings illustrates a drive member 1 and a pawl 3 of a conventional reversible ratcheting wrench. The drive member 1 has a plurality of teeth 2 on an outer periphery thereof, and the pawl 3 has a plurality of teeth 4 on a side thereof. The teeth 2 of the drive member 1 has a radius of curvature Ra the same as that of the teeth 4 of the pawl 3, allowing all of the teeth 4 of the pawl 3 to mesh with the teeth 2 of the drive member 1. Nevertheless, if the force exerting on the pawl 3 exceeds a predetermined value, the pawl 3 will pivot about an end portion of the pawl 3 such that the teeth on the other end portion of the pawl 3 disengage from the teeth 2 of the drive member 1, which is known as a “seesaw” effect. As a result, only three of the teeth 4 of the pawl 3 mesh with the teeth 2 of the drive member 1, and these three teeth 4 gradually wear or even break. Further, the torque-bearing capacity is reduced.

FIG. 2 illustrates a drive member 1 and a pawl 5 of another conventional reversible ratcheting wrench. The pawl 5 has two teeth sections 6 and 7 on a face thereof, with the teeth section 6 having a radius of curvature Rb1 the same as that Rb2 of the teeth section 7, and with the center of curvature of the teeth section 6 being located at a position other than that of the teeth section 7. Thus, the teeth section 6 of the pawl 5 mesh with the teeth 2 of the drive member 1 and the teeth section 7 of the pawl 5 are disengaged from the teeth 2 of the drive member 1 when a handle (not shown) is tuned in a direction for driving a fastener (not shown). On the other hand, the teeth section 7 of the pawl 5 mesh with the teeth 2 of the drive member 1 and the teeth section 6 of the pawl 5 are disengaged from the teeth 2 of the drive member 1 when a handle (not shown) is tuned in a reverse direction for driving a fastener (not shown). This arrangement avoids the seesaw effect and increases the torque-bearing capacity. However, manufacture of the pawl 5 requires more processing procedures, leading to an increase in the cost.

### SUMMARY OF THE INVENTION

An object of the present invention is to provide a wrench having a pawl that can be easily manufactured while avoiding the seesaw effect.

In accordance with an aspect of the invention, a reversible ratcheting wrench comprises a handle having a head, a drive member rotatably received in a hole of the head, and a pawl received in a compartment that is defined in an inner periphery delimiting the hole of the head and that is communicated with the hole. A plurality of teeth are provided on an outer periphery of the drive member and have a radius of curvature.

The pawl is slidable between a first ratcheting position corresponding to a first ratcheting direction of the wrench and a second ratcheting position corresponding to a second ratcheting position of the wrench that is opposite to the first ratcheting direction. The pawl includes a plurality of teeth on a toothed side thereof. The teeth of the pawl have a radius of curvature larger than that of the teeth of the drive member.

When the pawl is in the first ratcheting position, a portion of the teeth of the pawl engages with the teeth of the drive member while the other portion of the teeth of the pawl disengages from the teeth of the drive member, leaving a gap between the other portion of the pawl and the teeth of the drive member.

When the pawl is in the second ratcheting position, the other portion of the teeth of the pawl engages with the teeth of the drive member while the portion of the teeth of the pawl disengages from the teeth of the drive member, leaving a gap between the portion of the pawl and the teeth of the drive member.

The seesaw effect is avoided by the gap while providing an increased torque-bearing capacity.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a drive member and a pawl of a conventional reversible ratcheting wrench.

FIG. 2 is a schematic view of a drive member and a pawl of another conventional reversible ratcheting wrench.

FIG. 3 is a perspective view of a main portion of a reversible ratcheting wrench in accordance with the present invention.

FIG. 4 is an exploded perspective view of the main portion of the reversible ratcheting wrench in accordance with the present invention.

FIG. 5 is a schematic top view of a drive member and a pawl of the reversible ratcheting wrench in accordance with the present invention.

FIG. 6 is a top view, partly sectioned, of the main portion of the reversible ratcheting wrench.

FIG. 6A is an enlarged view of a left circled portion in FIG. 6.

FIG. 6B is an enlarged view of a right circled portion in FIG. 6.

FIG. 7 is a view similar to FIG. 6, wherein the pawl is in a position allowing counterclockwise ratcheting and clockwise free rotation of the drive member.

FIG. 7A is an enlarged view of a left circled portion in FIG. 7.

FIG. 7B is an enlarged view of a right circled portion in FIG. 7.

FIG. 8 is a view similar to FIG. 6, wherein the pawl is in a position allowing clockwise ratcheting and counterclockwise free rotation of the drive member.

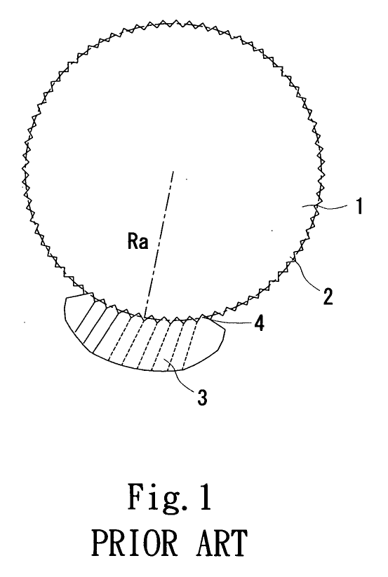

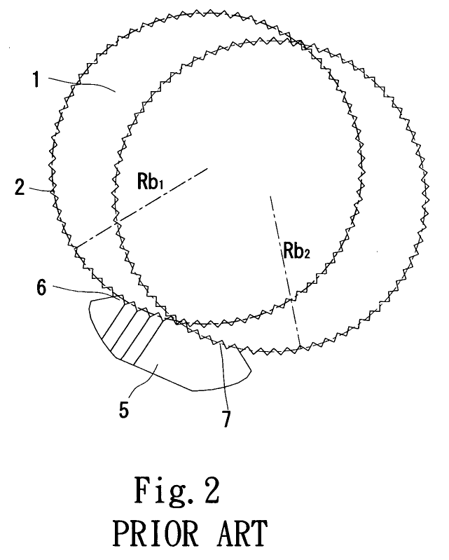

### DETAILED DESCRIPTION OF THE PREFERRED EMBODIMENT

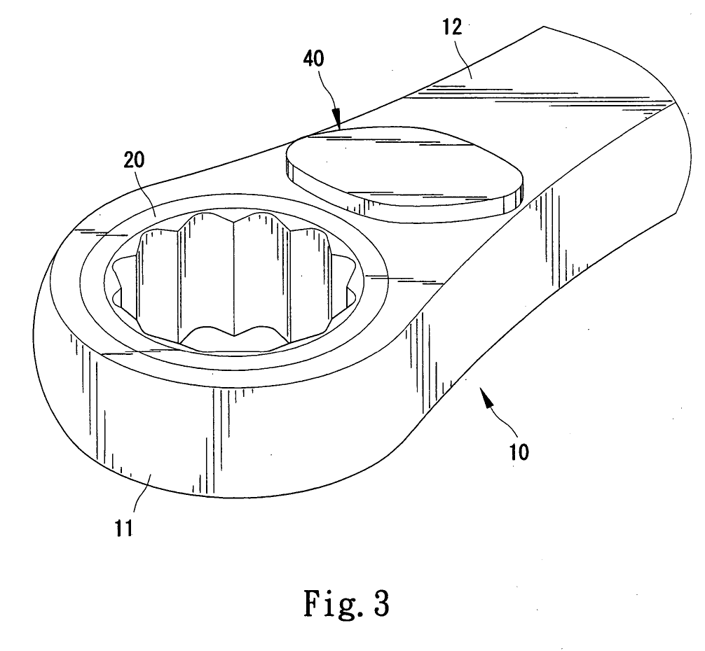

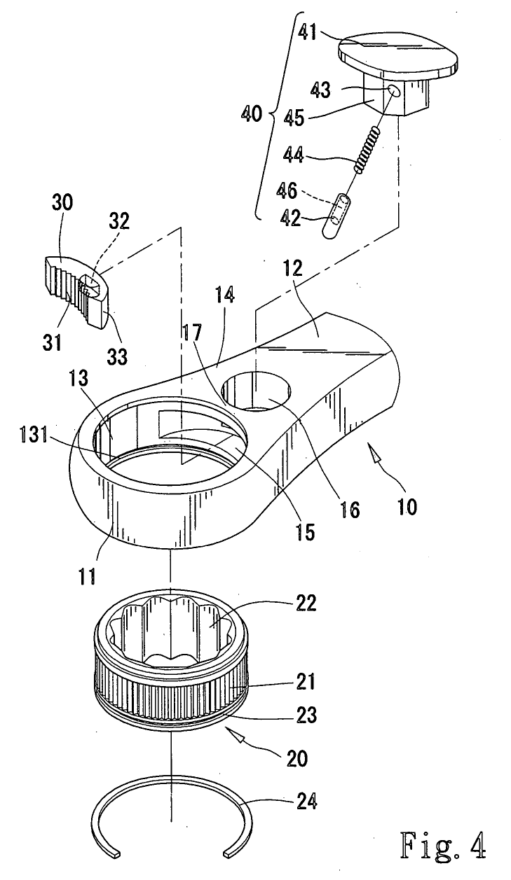

Referring to FIGS. 3 through 5, a high torque reversible ratcheting wrench in accordance with the present invention comprises a handle 10, a drive member 20, a pawl 30, and a switching means 40. The drive member 20 is rotatably mounted in a head 11 formed on an end of the handle 10. The handle 10 has a grip portion 12 on the other end thereof. In this embodiment, the head 11 includes a hole 13 for rotatably receiving the drive member 20. An annular groove 131 is defined in an inner periphery delimiting the hole 13. The handle 10 further includes a mounting hole 16 extending in a direction substantially parallel to that of the hole 13 of the head 11. Further, a compartment 15 is defined in the inner periphery delimiting the hole 13 of the head 11 and provides communication between the hole 13 and the mounting hole 16. As illustrated in FIG. 4, a bridge 17 integral with a web 14 of the handle 10 is formed, improving the strength of the structure between the head 11 and the grip portion 12.

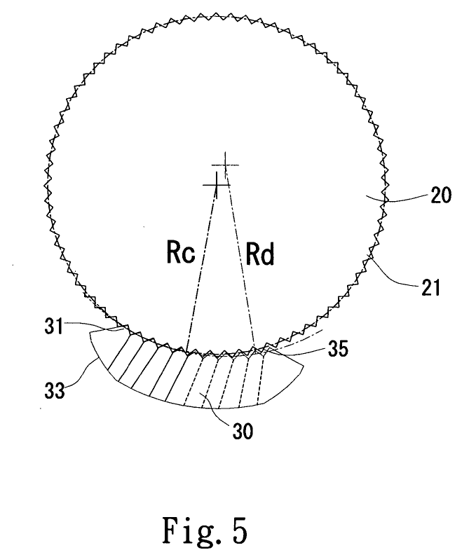

The drive member 20 includes a plurality of teeth 21 on an outer periphery thereof, preferably on an intermediate portion of the outer periphery. The teeth 21 have a radius of curvature Rc (FIG. 5). As illustrated in FIG. 4, the drive member 20 includes an inner periphery 22 configured for driving a fastener (not shown). Further, an annular groove 23 is defined in a lower end of the outer periphery, with a retainer 24 (such as a C-clip) partially received in the annular groove 23 of the drive member 20 and partially received in the annular groove 131 of the head 11, thereby rotatably mounting the drive member 20 in the head 11.

The pawl 30 includes a toothed side 31, a recess 32 defined in another side opposite to the toothed side 31, and two abutting faces 33. The toothed side 31 includes a plurality of teeth having a radius of curvature Rd greater than the radius of curvature Rc of the teeth 21 of the drive member 2, as shown in FIG. 5. The pawl 30 is slidably mounted in the compartment 15 of the handle 10. Although the radius of curvature Rd of the teeth of the pawl 30 is different from that of the teeth 21 of the drive member 2, the teeth of the pawl 30 have a single radius of curvature, allowing easy processing of the pawl 30 without increasing the manufacturing cost.

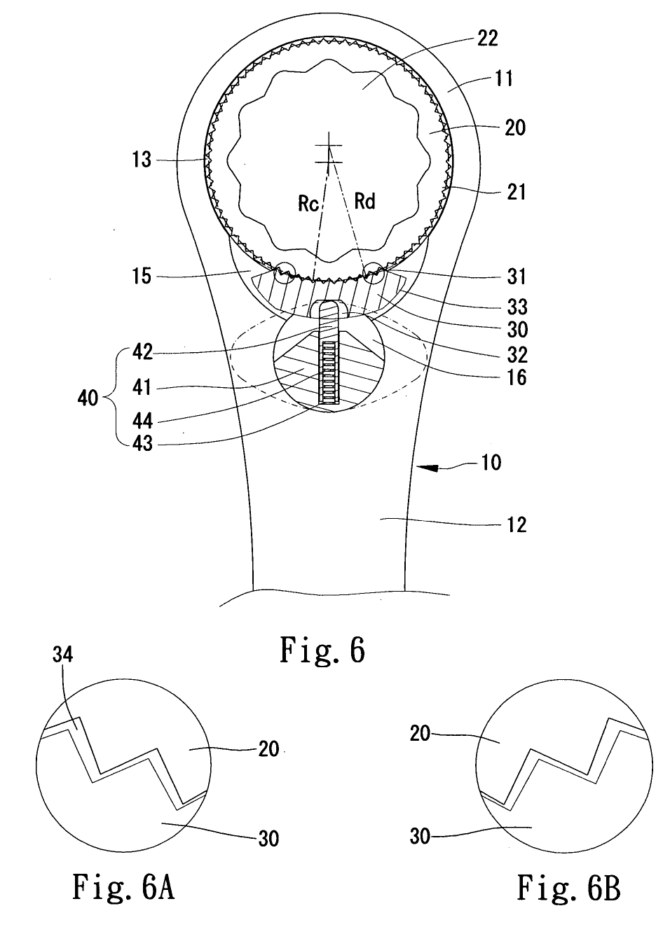

The switching means 40 can be operated to move the pawl 30 according to the desired ratcheting direction. In this embodiment, the switching means 40 includes a body 45 rotatably received in the mounting hole 16 of the handle 10, a turn piece 41 formed on a side of the body 45 and located outside the hole 16 for manual operation, an elastic element 44, and a pressing member 42. The elastic element 44 has a first end received in a receptacle 43 in the body 45 and a second end received in a receptacle 46 in an end of the pressing member 42. As illustrated in FIG. 6, the pressing member 42 is biased by the elastic element 44 into the recess 32 of the pawl 30, with the other end of the pressing member 42 pressing against a bottom wall delimiting the recess 32.

When the pawl 30 is in a neutral position in FIG. 6, the teeth of the pawl 30 are disengaged from the teeth 21 of the drive member 20, as shown in FIGS. 6A and 6B.

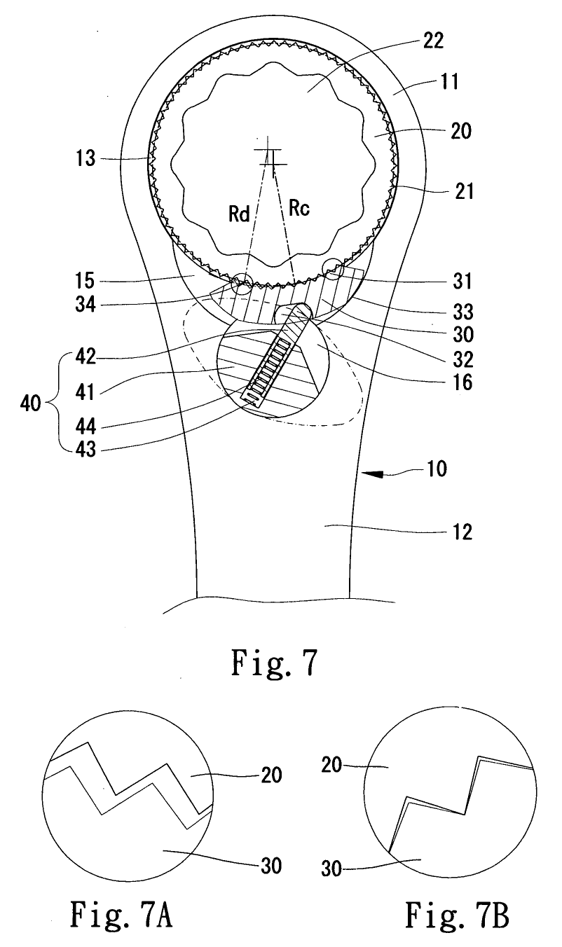

When the pawl 30 is moved to a ratcheting position shown in FIG. 7 through manual turning of the turn piece 41, one of the abutting faces 33 (the right one in FIG. 7) presses against a wall portion delimiting the compartment 15 of the handle 10 under the action of the elastic element 44. Further, as illustrated in FIG. 7B, a right portion of the teeth of the pawl 30 meshes with the teeth 21 of the drive member 2 while a left portion of the teeth of the pawl 30 are disengaged from the teeth 21 of the drive member 2, leaving a gap 34 between the left portion of the teeth of the pawl 30 as shown in FIG. 7A. This is because the teeth of the pawl 30 have a radius of curvature Rd greater than the radius of curvature Rc of the teeth 21 of the drive member 2. The seesaw effect is avoided. Further, the force exerting on the pawl 30 is uniformly distributed to every tooth of the right portion of the toothed portion of the pawl 30 meshed with the teeth 21 of the drive member 2. The torque-bearing capacity is increased. When in this ratcheting position, a fastener (not shown) engaged with the inner periphery 22 of the drive member 20 is driven counterclockwise when the handle 10 is turned counterclockwise, and the drive member 20 is not turned when the handle 10 is turned clockwise, which is conventional.

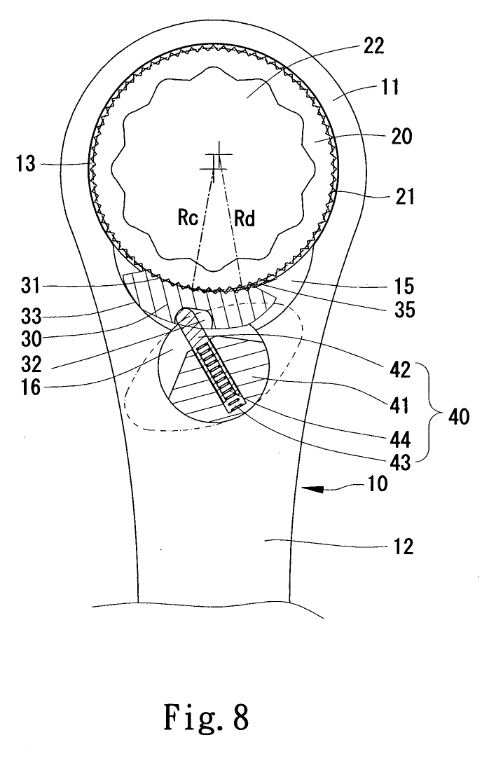

Similarly, when the pawl 30 is moved to a ratcheting position shown in FIG. 8 through manual turning of the turn piece 41, the other abutting face 33 (the left one in FIG. 8) presses against another wall portion delimiting the compartment 15 of the handle 10 under the action of the elastic element 44. Further, as illustrated in FIG. 8, the left portion of the teeth of the pawl 30 meshes with the teeth 21 of the drive member 2 (see FIG. 7B) while the right portion of the teeth of the pawl 30 are disengaged from the teeth 21 of the drive member 2, leaving a gap 35 between the right portion of the teeth of the pawl 30 (see FIG. 7A). This is because the teeth of the pawl 30 have a radius of curvature Rd greater than the radius of curvature Rc of the teeth 21 of the drive member 2. The seesaw effect is avoided. Further, the force exerting on the pawl 30 is uniformly distributed to every tooth of the right portion of the toothed portion of the pawl 30 meshed with the teeth 21 of the drive member 2. The torque-bearing capacity is increased. When in this ratcheting position, a fastener (not shown) engaged with the inner periphery 22 of the drive member 20 is driven clockwise when the handle 10 is turned clockwise, and the drive member 20 is not turned when the handle 10 is turned counterclockwise, which is also conventional.

It is noted that switching means is not limited to the switching means 40 shown and described. Other suitable arrangements can be adopted to move the pawl 30 between two positions corresponding to two opposite ratcheting directions, and these arrangements still fall within the scope of the present invention.

Although the invention has been explained in relation to its preferred embodiment, it is to be understood that many other possible modifications and variations can be made without departing from the scope of the invention as hereinafter claimed.

What is claimed is:

1. A reversible ratcheting wrench comprising:
a handle including a head, the head including a hole delimited by an inner periphery, a compartment being defined in the inner periphery delimiting the hole and communicated with the hole;
a drive member rotatably received in the hole of the head, a plurality of teeth being provided on an outer periphery of the drive member and having a radius of curvature; and
a pawl received in the compartment of the handle, the pawl being slidable between a first ratcheting position corresponding to a first ratcheting direction of the wrench and a second ratcheting position corresponding to a second ratcheting position of the wrench that is opposite to the first ratcheting direction, the pawl including a plurality of teeth on a toothed side thereof, the teeth of the pawl having a radius of curvature larger than that of the teeth of the drive member;
wherein when the pawl is in the first ratcheting position, a portion of the teeth of the pawl engages with the teeth of the drive member while another portion of the teeth of the pawl disengages from the teeth of the drive member, leaving a gap between said another portion of the pawl and the teeth of the drive member; and
wherein when the pawl is in the second ratcheting position, said another portion of the teeth of the pawl engages with the teeth of the drive member while the portion of the teeth of the pawl disengages from the teeth of the drive member, leaving a gap between the portion of the pawl and the teeth of the drive member.

2. The reversible ratcheting wrench as claimed in claim 1, wherein an annular groove is defined in the inner periphery delimiting the hole of the handle, the outer periphery of the drive member having an annular groove defined therein, further including a retainer partially received in the annular groove of the handle and partially received in the annular groove of the drive member, thereby rotatably mounting the drive member in the hole of the handle.

3. The reversible ratcheting wrench as claimed in claim 1, wherein the pawl includes two abutting faces selectively abutting against an associated one of two wall portions delimiting the compartment of the handle.

4. The reversible ratcheting wrench as claimed in claim 1, further including a switching means for moving the pawl between the first ratcheting position and the second ratcheting position.

5. The reversible ratcheting wrench as claimed in claim 4, wherein the switching means includes a body rotatably received in the handle and a turn piece formed on an end of the body and outside the handle for manual operation, the body including a receptacle, the switching means further including an elastic element and a pressing member, the elastic element having a first end received in the receptacle of the body and a second end for biasing the pressing member against the pawl, the pawl being moved between the first ratcheting position and the second ratcheting position when the turn piece is manually turned.

6. The reversible ratcheting wrench as claimed in claim 5, wherein the pawl includes another side opposite to the toothed side, said another side of the pawl including a recess for receiving an end of the pressing member.

7. The reversible ratcheting wrench as claimed in claim 5, wherein the pressing member includes a receptacle for receiving the second end of the elastic element.

8. The reversible ratcheting wrench as claimed in claim 5, wherein the handle includes a mounting hole communicated with the compartment, and wherein the body is rotatably mounted in the mounting hole of the handle.
